(19) United States
(12) Patent Application Publication
(10) Pub. No.: US 2006/0102249 A1
(43) Pub. Date: May 18, 2006

(54) Router with drive shaft lock mechanism

(76) Inventors: Randy G. Cooper, Jackson, TN (US); Mark A. Etter, Humboldt, TN (US); Greg K. Griffin, Humboldt, TN (US); Ginger L. Allen, Jackson, TN (US); Derrick Kilbourne, Deerfield Beach, FL (US)

Correspondence Address: THE BLACK & DECKER CORPORATION, 701 EAST JOPPA ROAD, TW199, TOWSON, MD, 21286, US

(21) Appl. No.: 10/836,900

(22) Filed: Apr. 30, 2004

Related U.S. Application Data
(60) Provisional application No. 60/467,169, filed on May 1, 2003.

(51) Int. Cl. B27C 5/10; B27C 1/00

(52) U.S. Cl. 144/136.95; 144/154.5

(57) ABSTRACT

The present invention is directed to a router with a drive shaft lock mechanism. In an exemplary aspect of the present invention, a router with a drive shaft lock mechanism includes: (1) a motor housing for at least partially containing a motor for rotating a drive shaft, the drive shaft being suitable for receiving a router bit; (2) a shaft lock, mounted to the motor housing, for selectively engaging the drive shaft to prevent rotation; (3) a base unit for adjustably receiving the motor housing; and (4) a shaft lock actuator coupled to the base unit, the shaft lock actuator being configured to obtain a released position and a locked position, wherein the shaft lock actuator, when disposed in the locked position, causes the shaft lock to be in an engaging position for preventing the drive shaft from rotation when the drive shaft is disposed adjacent the shaft lock actuator.

### CROSS-REFERENCE TO RELATED DOCUMENTS

The present application claims the benefit under 35 U.S.C. § 119(e) of U.S. Provisional Application Ser. No. 60/467,169, entitled Router, filed May 1, 2003. The U.S. Provisional Application Ser. No. 60/467,169 is herein incorporated by reference in its entirety.

The present application herein incorporates the following U.S. Patent Applications by reference in their entirety:

| Attorney Docket Number | Filing Date | Serial Number |
|---|---|---|
| PTG 02-112-1 | Dec. 18, 2003 | 10/740,235 |
| PTG 02-114-1 | Mar. 7, 2003 | 10/384,510 |
| PTG 02-115-1 | Jun. 10, 2003 | 10/458,167 |
| PTG 02-116-1 | Dec. 8, 2003 | 10/730,637 |
| PTG 02-117-1 | Oct. 15, 2003 | 10/686,300 |

### FIELD OF THE INVENTION

The present invention relates generally to routers, and particularly to a drive shaft lock mechanism.

### BACKGROUND OF THE INVENTION

A router is a wood working power tool used to cut grooves, hollow out areas, or create shaped trims along the edge of a workpiece. The form of cuts created is determined by the size and shape of a bit held in a drive shaft of the router. The router often includes a vertically mounted motor that drives the drive shaft, with the bit, held in a collet, projecting out through a flat base. There are two standard types of router: plunge routers and fixed routers. With a plunge router, the bit can be lowered into the workpiece or plunged into the filed of the workpiece; with a fixed router, the cut depth is set and the bit is utilized to remove the material. Alternatively, the router may be mounted below a table and used in conjunction with a fence.

Router bits often come in hundreds of varieties to create both decorative effects as well as joinery aids. Router bits are classifies as either high-speed steel (HSS) or carbide-tipped, and can be edge bits or non-edge bits. Edge bits have a small wheel bearing to aid a router along the edge of a workpiece without using a rip fence. Non-edge bits are guided with a straight edge, rip fence, or a router table.

A router user often changes bits repeatedly during the course of a project. For example, the user may first use a strait cutting bit to form a rabbit for a shelf and then switch to a dovetail bit to dovetail a drawer. Therefore, methods are used to facilitate bit changes. For instance, drive shaft locks may be utilized to prevent rotation of the shaft when changing bits. However, conventional shaft locks may be problematic in so much as the device may require the user to manually depress the shaft lock in order to prevent the drive shaft from rotation, which may make the user unable to grasp the router firmly during bit changes.

Thus, it would be desirable to provide a router with a drive shaft lock mechanism, which may, during bit changes, prevent the drive shaft from rotating and eliminate the need for a user to manually depress the shaft lock.

### SUMMARY OF THE INVENTION

Accordingly, the present invention is directed to a router with a drive shaft lock mechanism. In a first exemplary aspect of the present invention, a router with a drive shaft lock mechanism includes: (1) a motor housing for at least partially containing a motor for rotating a drive shaft, the drive shaft being suitable for receiving a router bit; (2) a shaft lock, mounted to the motor housing, for selectively engaging the drive shaft to prevent rotation; (3) a base unit for adjustably receiving the motor housing; and (4) a shaft lock actuator coupled to the base unit, the shaft lock actuator being configured to obtain a released position and a locked position, wherein the shaft lock actuator, when disposed in the locked position, causes the shaft lock to be in an engaging position for preventing the drive shaft from rotation when the drive shaft is disposed adjacent the shaft lock actuator.

In an additional exemplary aspect of the present invention, a router with a drive shaft lock mechanism includes: (1) a motor housing for at least partially containing a motor for rotating a drive shaft, the drive shaft including a collet for holding a router bit; (2) a shaft lock, mounted to the motor housing, for selectively engaging the drive shaft to prevent rotation; (3) a base unit for adjustably receiving the motor housing, the base unit including a mechanical interlock; and (4) a shaft lock actuator pivotally mounted to the mechanical interlock, the shaft lock actuator being configured to obtain a released position and a locked position, wherein the shaft lock actuator, when disposed in the locked position, causes the shaft lock to be in an engaging position for preventing the drive shaft from rotation when the collet extends through the base unit.

In another exemplary aspect of the present invention, a router with a drive shaft lock mechanism includes: (1) a motor housing for at least partially containing a motor for rotating a drive shaft, the drive shaft including a collet for holding a router bit; (2) a biased pin, mounted to the motor housing, for selectively engaging the drive shaft to prevent rotation; (3) a base unit for adjustably receiving the motor housing, the base unit including a mechanical interlock; and (4) a shaft lock actuator pivotally mounted to the mechanical interlock, the shaft lock actuator including an inclined surface and being configured to obtain a released position and a locked position, wherein the inclined surface, when the shaft lock actuator is disposed in the locked position, causes the biased pin to be in an engaging position for preventing the drive shaft from rotation when the collet extends fully through the base unit.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view of a router including a drive shaft, a shaft lock and a shaft lock actuator in accordance with an exemplary embodiment of the present invention;

FIG. 2 is a partial isometric view of the router shown in FIG. 1, where the shaft lock and the shaft lock actuator are shown in more detail;

FIG. 3 is a partial elevation view of the router shown in FIG. 1, where the shaft lock actuator is shown in a locked position;

FIG. 4 is a partial elevation view of the router shown in FIG. 1, where the shaft lock actuator is shown in a locked position and where the shaft lock actuator causes the shaft lock to engage the drive shaft;

FIG. 5 is a partial top plan view of the router shown in FIG. 1, where an inclined surface of the shaft lock actuator is shown; and

FIG. 6 is a partial isometric view of the router shown in FIG. 1, where the shaft lock actuator is shown in a released position.

### DETAILED DESCRIPTION OF THE INVENTION

Reference will now be made in detail to the presently preferred embodiments of the invention, examples of which are illustrated in the accompanying drawings.

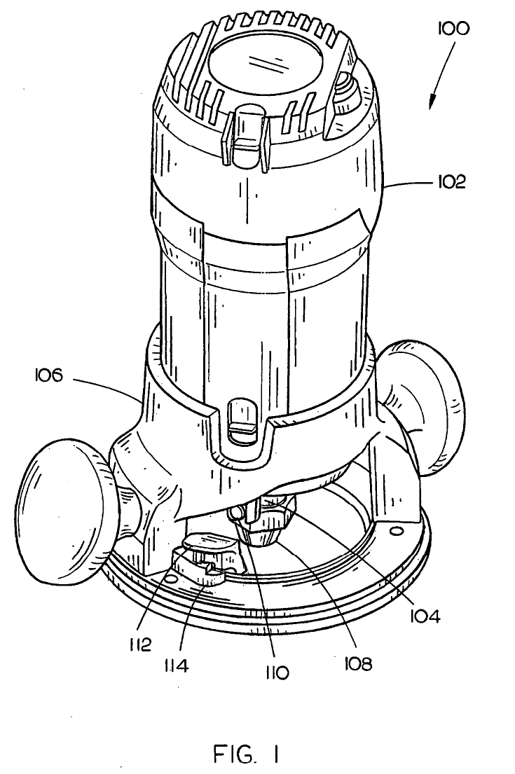

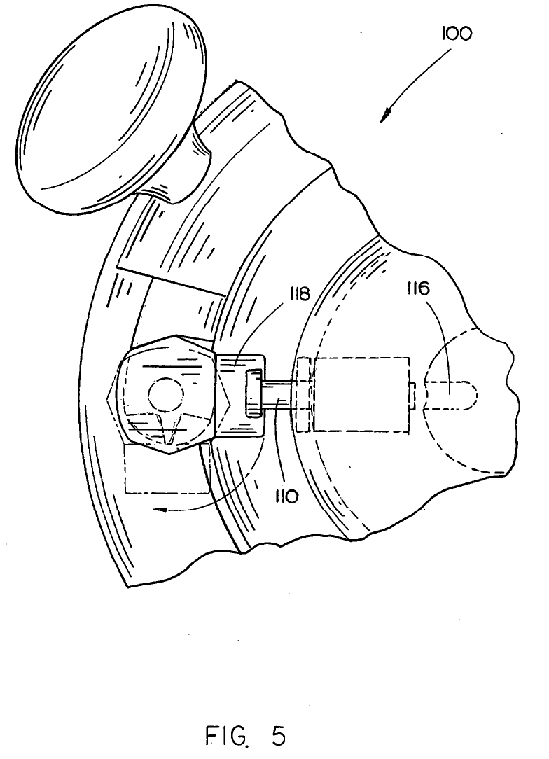

Referring to FIGS. 1 through 6, a router 100 in accordance with an exemplary embodiment of the present invention is shown. In FIGS. 1 through 6, the router 100 is shown as a fixed router. However, it is understood that the present invention may be implemented in a plunge router, a router table, and the like without departing from the scope and spirit of the present invention. As shown, the router 100 includes a motor housing 102 for at least partially containing a motor for rotating a drive shaft 104, and a base unit 106 for adjustably receiving the motor housing 102. The base unit 106 may provide a support surface for the router 100. The drive shaft 104 may include a collet 108 for holding a router bit.

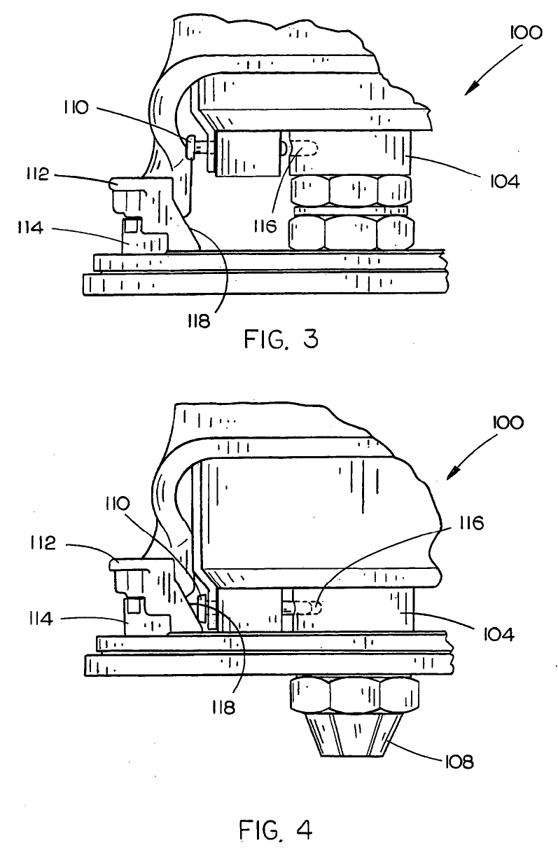

The router 100 includes a shaft lock 110 mounted to the router housing 102, generally perpendicular to the drive shaft 104, for selectively engaging/disengaging the drive shaft 104. When disposed in a disengaging position (see, e.g., FIG. 3), the shaft lock 110 does not engage the shaft lock 110, and the shaft lock 110 is free to rotate. When disposed in an engaging position (see, e.g., FIG. 4), the shaft lock 110 engages the shaft lock 110, and the shaft lock 110 is prevented from rotating. Preferably, the shaft lock 110 engages a flat portion or recess 116 on the drive shaft 104 to prevent the drive shaft 104 from rotating when the shaft lock 110 is in the engaging position. In an exemplary embodiment, the shaft lock 110 may be a biased pin as described in the co-pending U.S. patent application Ser. No. 10/458,167, entitled Switch Assembly, filed Jun. 10, 2003, and the biased pin may be biased by a spring into the disengaged position. The biased pin may be disposed in the engaging position by a device overcoming spring force of the biased pin. It is understood that other shaft locks as contemplated by a person of ordinary skill in the art may be used without departing from the scope and spirit of the present invention.

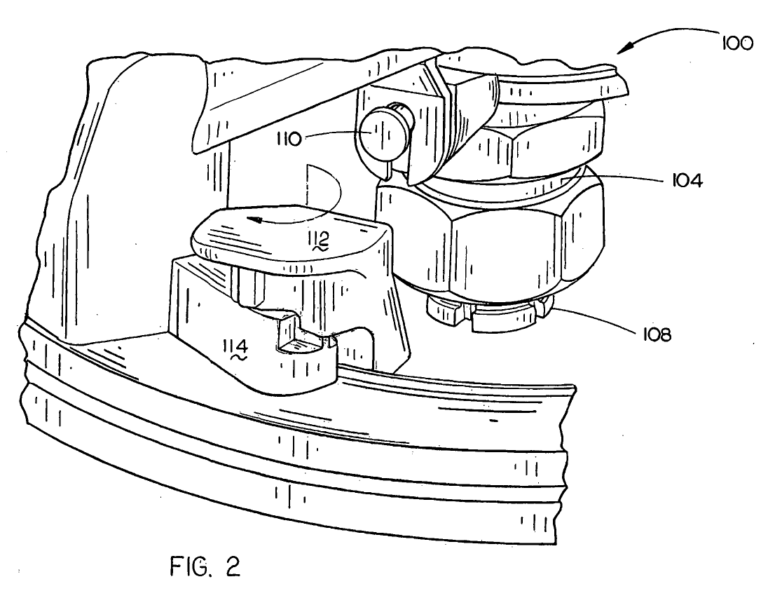

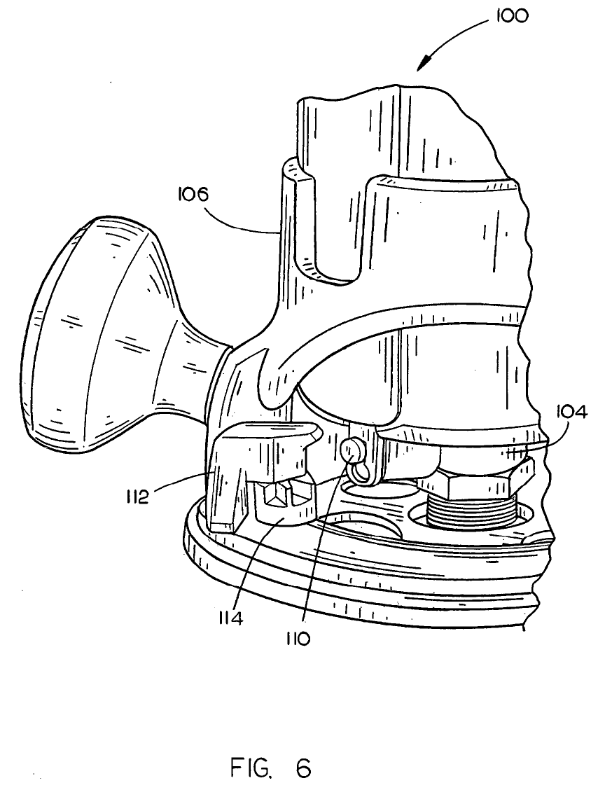

The present invention provides a shaft lock actuator 112 included in the router 100, which is coupled to the base unit 106. The shaft lock actuator 112 is configured to obtain a released position (see, e.g., FIG. 6) and a locked position (see, e.g., FIGS. 2 through 4). As shown in FIG. 4, when disposed in the locked position, the shaft lock actuator 112 may cause the shaft lock 110 to be in the engaging position for preventing the drive shaft 104 from rotation when the drive shaft 104 is disposed adjacent the shaft lock actuator 112 (e.g., when the collet 108 extends fully through the base unit 106), thereby locking the drive shaft 104 for bit changes or for preventing accidental bit rotation. Thus, using the shaft lock actuator 112 to automatically lock the drive shaft 104, the need for a user to manually depress the shaft lock 110 when changing the router bit may be eliminated, thereby allowing the user to securely grasp the router 100. When disposed in the released position (see, e.g., FIG. 6), the shaft lock actuator 112 allows the shaft lock 110 to be in the disengaging position so that the drive shaft 104 is free to rotate, thereby minimizing the potential accidental engagement of the shaft lock 110.

In an exemplary embodiment, the shaft lock actuator 112 is coupled to the base unit 106 via a mechanical interlock 114 included in the base unit 106. In an exemplary embodiment, the mechanical interlock 114 is a pedestal. However, it is understood that other mechanical interlocks in various forms, shapes and the like, as contemplated by a person of ordinary skill in the art, may be used without departing from the scope and spirit of the present invention.

Preferably, the shaft lock actuator 112 is pivotally mounted to the mechanical interlock 114 or the base unit 106 and is configured to rotate between at least a released position (see, e.g., FIG. 6) and a locked position (see, e.g., FIGS. 2 through 5). Alternatively, the shaft lock actuator 112 is slid onto the mechanical interlock 114 or the base unit 106. The shaft lock actuator 112 may be biased and may be lifted from the mechanical interlock 114 or the base unit 106 when rotating between the locked position and the released position. For example, as shown in FIG. 2, when disposed in the locked position, the shaft lock actuator 112 may be lifted from the mechanical interlock 114 and rotated to the released position (see FIG. 6) and released. As shown in FIGS. 2 through 4, when disposed in the locked position, supported by the mechanical interlock 114, the shaft lock actuator 112 may cause the shaft lock 110 to be in the engaging position for preventing the drive shaft 104 from rotation when the drive shaft 104 is disposed adjacent the shaft lock actuator 112 (e.g., when the collet 108 extends fully through the base unit 106).

Preferably, the shaft lock actuator 112 includes a wedge shaped or inclined surface 118 for depressing the shaft lock 110 (see, e.g., FIGS. 3 through 5). In the locked position, the inclined surface 118 is disposed in a path of the shaft lock 110 as the motor housing 102 moves relative to the base unit 106. For instance, as the motor housing 102 is manipulated with respect to the base unit 106, upon contacting the inclined surface 118 disposed in the locked position, the shaft lock 110 is driven into contact with the drive shaft 104, thereby securing the drive shaft 104. When disposed in the released position, the inclined surface 118 is not in the path of the shaft lock 110, thereby allowing the user full depth adjustment. It is understood that other shaft lock actuators in various forms, shapes, and the like, as contemplated by a person of ordinary skill in the art, may be used without departing from the scope and spirit of the present invention.

The present invention may eliminate the need for a user to manually depress the shaft lock when changing the router bits, thereby allowing the user to securely grasp the router. Moreover, the present invention may minimize accidental engagement of the shaft lock, which may result in damage to the router.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages, the form herein before described being merely an explanatory embodiment thereof. It is the intention of the following claims to encompass and include such changes.

What is claimed is:

1. A router with a drive shaft lock mechanism, comprising:
a motor housing for at least partially containing a motor for rotating a drive shaft, the drive shaft suitable for receiving a router bit;
a shaft lock, mounted to the motor housing, for selectively engaging the drive shaft to prevent rotation;
a base unit for adjustably receiving the motor housing; and
a shaft lock actuator coupled to the base unit, the shaft lock actuator being configured to obtain a released position and a locked position,
wherein the shaft lock actuator, when disposed in the locked position, causes the shaft lock to be in an engaging position for preventing the drive shaft from rotation when the drive shaft is disposed adjacent the shaft lock actuator.

2. The router of claim 1, wherein the shaft lock actuator, when disposed in the released position, allows the shaft lock to be in a disengaging position so that the drive shaft is free to rotate.

3. The router of claim 1, wherein the shaft lock actuator is pivotally mounted to the base unit.

4. The router of claim 3, wherein the shaft lock actuator is biased and is lifted from the base unit when rotating between the locked position and the released position.

5. The router of claim 1, wherein the shaft lock actuator is mounted to the base unit through a sliding means.

6. The router of claim 1, wherein the shaft lock is a biased pin.

7. The router of claim 6, wherein the biased pin, when in a disengaging position, is biased by a spring so that the drive shaft is free to rotate.

8. The router of claim 6, wherein the shaft lock actuator, when disposed in the locked position, overcomes spring force of the biased pin and causes the biased pin to be in the engaging position for preventing the drive shaft from rotation when the drive shaft is disposed adjacent the shaft lock actuator.

9. The router of claim 8, wherein the drive shaft includes a flat portion so that when the biased pin engages the flat portion, the drive shaft is prevented from rotating.

10. The router of claim 8, wherein the drive shaft includes a recess so that when the biased pin engages the recess, the drive shaft is prevented from rotating.

11. The router of claim 6, wherein the biased pin is generally perpendicular to the drive shaft.

12. A router with a drive shaft lock mechanism, comprising:
a motor housing for at least partially containing a motor for rotating a drive shaft, the drive shaft including a collet for holding a router bit;
a shaft lock, mounted to the motor housing, for selectively engaging the drive shaft to prevent rotation;
a base unit for adjustably receiving the motor housing, the base unit including a mechanical interlock; and
a shaft lock actuator pivotally mounted to the mechanical interlock, the shaft lock actuator being configured to obtain a released position and a locked position,
wherein the shaft lock actuator, when disposed in the locked position, causes the shaft lock to be in an engaging position for preventing the drive shaft from rotation when the collet extends through the base unit.

13. The router of claim 12, wherein the shaft lock actuator, when disposed in the released position, allows the shaft lock to be in a disengaging position so that the drive shaft is free to rotate.

14. The router of claim 12, wherein the shaft lock actuator includes an inclined surface for causing the shaft lock to be in the engaging position for preventing the drive shaft from rotation when the shaft lock actuator is disposed in the locked position and when the collet extends through the base unit.

15. The router of claim 12, wherein the shaft lock actuator is biased and is lifted from the mechanical interlock when rotating between the locked position and the released position.

16. The router of claim 12, wherein the shaft lock is a biased pin.

17. The router of claim 16, wherein the biased pin, when in a disengaging position, is biased by a spring so that the drive shaft is free to rotate.

18. The router of claim 16, wherein the shaft lock actuator, when disposed in the locked position, overcomes spring force of the biased pin and causes the biased pin to be in the engaging position for preventing the drive shaft from rotation when the collet extends through the base unit.

19. The router of claim 18, wherein the drive shaft includes a flat portion so that when the biased pin engages the flat portion, the drive shaft is prevented from rotating.

20. The router of claim 18, wherein the drive shaft includes a recess so that when the biased pin engages the recess, the drive shaft is prevented from rotating.

21. The router of claim 16, wherein the biased pin is generally perpendicular to the drive shaft.

22. The router of claim 16, wherein the mechanical interlock is a pedestal.

23. A router with a drive shaft lock mechanism, comprising:
a motor housing for at least partially containing a motor for rotating a drive shaft, the drive shaft including a collet for holding a router bit;
a biased pin, mounted to the motor housing, for selectively engaging the drive shaft to prevent rotation;
a base unit for adjustably receiving the motor housing, the base unit including a mechanical interlock; and
a shaft lock actuator pivotally mounted to the mechanical interlock, the shaft lock actuator including an inclined surface and being configured to obtain a released position and a locked position,
wherein the inclined surface, when the shaft lock actuator is disposed in the locked position, causes the biased pin to be in an engaging position for preventing the drive shaft from rotation when the collet extends fully through the base unit.

24. The router of claim 23, wherein the shaft lock actuator, when disposed in the released position, allows the biased pin to be in a disengaging position so that the drive shaft is free to rotate.

25. The router of claim 23, wherein the shaft lock actuator is biased and is lifted from the mechanical interlock when rotating between the locked position and the released position.

26. The router of claim 23, wherein the biased pin, when in a disengaging position, is biased by a spring so that the drive shaft is free to rotate.

27. The router of claim 26, wherein the shaft lock actuator, when disposed in the locked position, overcomes spring force of the biased pin and causes the biased pin to be in the engaging position for preventing the drive shaft from rotation when the collet extends through the base unit.

28. The router of claim 27, wherein the drive shaft includes a flat portion so that when the biased pin engages the flat portion, the drive shaft is prevented from rotating.

29. The router of claim 27, wherein the drive shaft includes a recess so that when the biased pin engages the recess, the drive shaft is prevented from rotating.

30. The router of claim 23, wherein the biased pin is generally perpendicular to the drive shaft.

31. The router of claim 23, wherein the mechanical interlock is a pedestal.
